(19) United States
(12) Patent Application Publication
(10) Pub. No.: US 2016/0284052 A1
(43) Pub. Date: Sep. 29, 2016

(54) IMAGE PROCESSING METHOD AND APPARATUS

(71) Applicant: Novatek Microelectronics Corp., Hsinchu (TW)

(72) Inventor: Chih-Kai Chang, Taichung City (TW)

(21) Appl. No.: 14/667,707

(22) Filed: Mar. 25, 2015

(51) Int. Cl. G06T 3/40; G06T 5/10

(52) U.S. Cl. CPC G06T 3/4007; G06T 5/10

(57) ABSTRACT

An image processing method and an image processing apparatus are provided. The method includes the following steps: detecting a pixel content of an input image around an interpolated pixel to obtain a weighted factor; adjusting a plurality of reference pixels according to the weighted factor; and generating an output image by performing an interpolation process based on a sinc filter according to the adjusted reference pixels, in which the method is performed using an integrated circuit or computer program.

### BACKGROUND OF THE INVENTION

1. Field of Invention

The invention relates generally to an image processing method and apparatus, and more particularly an image processing method and apparatus using a sinc filter.

2. Description of Related Art

Super resolution refers to techniques which preserve fine details after an image has been resized. The sinc filter has been used as a basis for a resampling kernel. However, since the sinc filter extends infinitely, in practice a discrete function with upper and lower limits is used, which is referred to as the Lanczos resampling kernel. For the Lanczos2 filter, also referred to as one type of windowed form of the sinc filter having a sampling size of 2, there are two symmetric reference points to the left, right, above, and below the interpolated pixel, and a total of 16 points are used as reference points for resampling. In practice, however, these conventional Lanczos2 resampling techniques result in complex hardware implementations and require extra line buffer resources. Moreover, these techniques exhibit negative responses in the spatial domain, which contribute to overshoot artifacts detrimental to image quality. Accordingly, an area of research emphasis is in overcoming the aforementioned issues while maintaining the favorable aspects of super resolution.

### SUMMARY OF THE INVENTION

The invention provides an image processing method and an image processing apparatus. The method includes the following steps: detecting a pixel content of an input image around an interpolated pixel to obtain a weighted factor; adjusting the value of a plurality of reference pixels according to the weighted factor; and generating an output image by performing an interpolation process based on a sinc filter according to the adjusted reference pixels, in which the method is performed using integrated circuit or computer program.

The image processing apparatus includes a neighborhood pixel content analyzer circuit, a neighborhood pixel processing circuit and a coefficient calculating and interpolation circuit. The neighborhood pixel content analyzer circuit is configured to receive an input image and detect a pixel content of the input image around an interpolated pixel to obtain a weighted factor. The neighborhood pixel processing circuit is coupled to the neighborhood pixel content analyzer circuit to receive the weighted factor. The neighborhood pixel processing circuit is configured to adjust a plurality of reference pixels to obtain a plurality of adjusted reference pixels according to the weighted factor. The coefficient calculating and interpolation circuit is coupled to the neighborhood pixel processing circuit. The coefficient calculating and interpolation circuit is configured to generate an output image by performing an interpolation process based on a sine filter according to the adjusted reference pixels.

In summary, according to embodiments of the invention, the image processing method and apparatus reduce the computational loading of the Lanczos2 resampling kernel, while also correcting for overshoot artifacts and maintaining image details.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a flow diagram of an image processing method according to an embodiment of the invention.

FIG. 2 is an image processing apparatus for performing the image processing method depicted in FIG. 1 according to an embodiment of the invention.

FIG. 3 is a schematic view of reference pixels near an interpolated pixel of the input image according to an embodiment of the invention.

FIGS. 4A, 4B, 4C are schematic views of different implementations of a content trait analyzing function according to an embodiment of the invention.

FIG. 5 is a schematic view of the reference pixels depicted in FIG. 3 shifted by the weighted factor according to an embodiment of the invention.

### DESCRIPTION OF EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

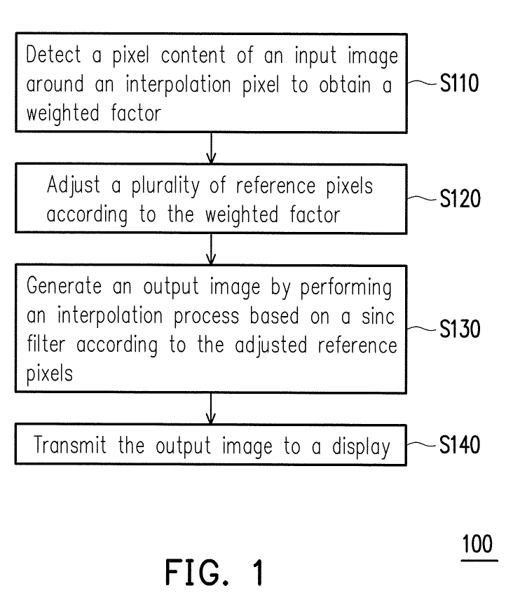

FIG. 1 is a flow diagram of an image processing method according to an embodiment of the invention. With reference to FIG. 1, in an image processing method 100 of the present embodiment, a pixel content of an input image is detected around an interpolated pixel to obtain a weighted factor in Step S110. In Step S120, a plurality of reference pixels are adjusted according to the weighted factor. In Step S130, an output image is generated by performing an interpolation process based on a sinc filter according to the adjusted reference pixels. In Step S140, the output image is transmitted to a display. In some embodiments, the afore-described method may be performed using an integrated circuit or computer program, for example.

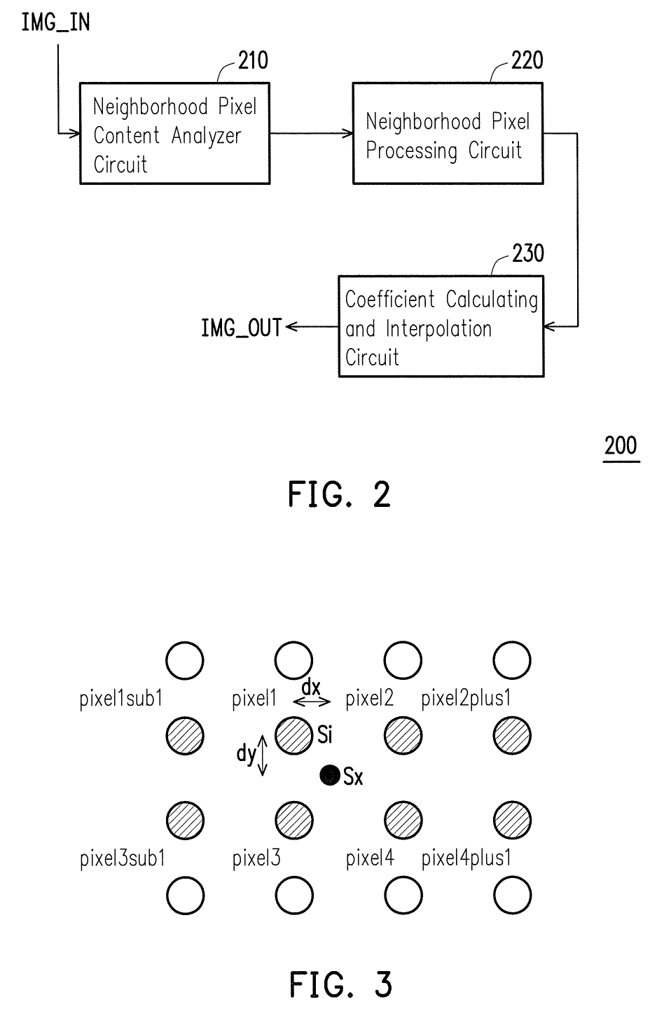

FIG. 2 is an image processing apparatus for performing the image processing method depicted in FIG. 1 according to an embodiment of the invention. With reference to FIG. 2, an image processing apparatus 200 of the present embodiment may include a neighborhood pixel content analyzer circuit 210, a neighborhood pixel processing circuit 220, and a coefficient calculating and interpolation circuit 230.

In specifics, an input image IMG_IN may be provided to the neighborhood pixel content analyzer circuit 210 to detect the pixel content of the input image IMG_IN at an interpolated pixel to obtain a weighted factor. For example, in one embodiment of the invention, the weighted factor may be obtained by characterizing a plurality of pixels near the interpolated pixel. FIG. 3 is a schematic view of reference pixels near an interpolated pixel Sx of the input image IMG_IN according to an embodiment of the invention. With reference to FIG. 3, in the present embodiment, an interpolated pixel Sx represented by the dark circle is interpolated by analyzing and resampling eight reference pixels Si. As shown in FIG. 3, the interpolated pixel may be a distance dx from one of the reference pixels Si in the x direction, and a distance dy in the y direction. In FIG. 3, pixel1sub1, pixel1, pixel2, and pixel2plus1 may represent the grayscale values of the reference pixels Si of the input image IMG_IN on one side of the interpolated pixel in sequence, and pixel3sub1, pixel3, pixel4, and pixel4plus1 may represent the grayscale values of the pixels of the input image on the other side of the interpolated pixel in sequence. In the present embodiment, only one line of reference pixels Si on each of two opposite sides of the interpolated pixel is used to calculate the pixels in an output image IMG_OUT to reduce hardware cost. In other words, only 8 multipliers in the x direction and 2 multipliers in the y direction are required to compute convolutions, and only two line buffers are needed when eight reference pixels Si are sampled. That is, the pixels represented by the empty circles above and below the slanted line circles in FIG. 3 are not sampled. It should be noted that, in other embodiments of the invention, the number of reference pixels Si is not limited to eight. However, if all sixteen pixels are sampled, a Lanczos2 filter would be much more complex to implement in practice, requiring 16 multipliers to calculate convolutions in the x direction and 4 multipliers to calculate a convolution in the y direction, as well as four extra line buffers for real-time calculations during raster scan for instance.

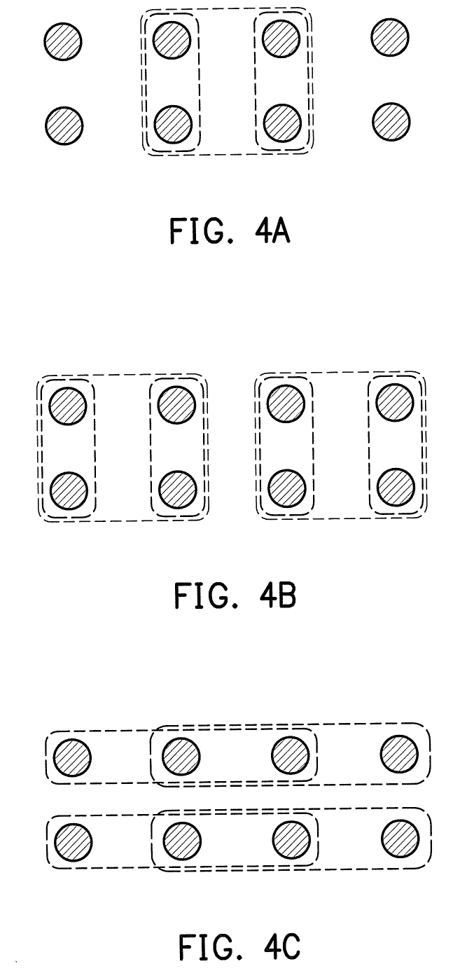

FIGS. 4A, 4B, 4C are schematic views of different implementations of a content trait analyzing function according to an embodiment of the invention. In FIGS. 4A-4C, the circles with slashed lines may represent pixel1sub1, pixel1, pixel2, pixel2plus1, pixel3sub1, pixel3, pixel4, and pixel4plus1 shown in FIG. 3, for example. With reference to FIG. 2 and FIG. 4A, in some embodiments of the invention, the process of obtaining the weighted factor by characterizing the pixels near the interpolated pixel includes calculating the weighted factor as:

shift=max(┌W×rect+M┐,S), wherein (1)

rect=max(|Vₚᵢₓₑₗ₁−Vₚᵢₓₑₗ₃|,|Vₚᵢₓₑₗ₂−Vₚᵢₓₑₗ₄|), (2)

where rect is the content trait analyzing function, shift is the weighted factor and an integer from 0 to 8, W, M, and S are variables, and Vₚᵢₓₑₗ₁, Vₚᵢₓₑₗ₂, Vₚᵢₓₑₗ₃, and Vₚᵢₓₑₗ₄ represent pixel brightness of four pixels near the interpolated pixel Sx. In FIG. 4A, the calculation of the content trait analyzing function rect is represented by the broken line rectangles in FIG. 4A. In some embodiments, the variables may be W=−½, M=8, and S=0 for calculating the weighted factor. In equation (1), the ┌ ┐ symbol represents a ceiling function. The neighborhood pixel content analyzer circuit 210 calculates the weighted factor by using equations (1) and (2), so as to analyze the pixel content of the reference pixels Si of the input image IMG_IN. The neighborhood pixel content analyzer circuit 210 then provides the weighted factor to the neighborhood pixel processing circuit 220 to adjust the reference pixels Si according to the weighted factor.

FIG. 4B and FIG. 4C depicts two other implementations of the content trait analyzing function rect, although it should be noted that the invention is not limited thereto, and other implementations are possible. As shown by the broken line rectangles in FIG. 4B, the neighborhood pixel content analyzer circuit 210 may calculate the content trait analyzing function rect by using the equation (3) as follows:

rect=min((max(|Vₚᵢₓₑₗ₁ₘᵢₙᵤₛ₁−Vₚᵢₓₑₗ₃ₘᵢₙᵤₛ₁|,|Vₚᵢₓₑₗ₁−Vₚᵢₓₑₗ₃|)),(max(|Vₚᵢₓₑₗ₂ₚₗᵤₛ₁−Vₚᵢₓₑₗ₄ₚₗᵤₛ₁|,|Vₚᵢₓₑₗ₂−Vₚᵢₓₑₗ₄|))) (3)

wherein Vₚᵢₓₑₗ₁ₘᵢₙᵤₛ₁ Vₚᵢₓₑₗ₃ₘᵢₙᵤₛ₁, Vₚᵢₓₑₗ₁, Vₚᵢₓₑₗ₂, Vₚᵢₓₑₗ₃, Vₚᵢₓₑₗ₄, Vₚᵢₓₑₗ₂ₚₗᵤₛ₁, and Vₚᵢₓₑₗ₄ₚₗᵤₛ₁ represent pixel brightness of eight pixels near the interpolated pixel Sx.

As shown in FIG. 4C, the neighborhood pixel content analyzer circuit 210 may also calculate the content trait analyzing function rect by using the equation (4) as follows:

rect=min((max(l₁,l₃)),(max(l₂,l₄))) (4)

where l₁, l₂, l₃, and l₄ represent the four rectangles shown in FIG. 4C and are defined as:
l₁=ABS3(pixel1, pixel2, pixel2plus1)
l₂=ABS3(pixel1, pixel2, pixel1minus1)
l₃=ABS3(pixel3, pixel4, pixel4plus1)
l₄=ABS3(pixel3, pixel4, pixel3minus1)
   where ABS3 (a,b,c)=MAX(a,b,c)−min(a,b,c).

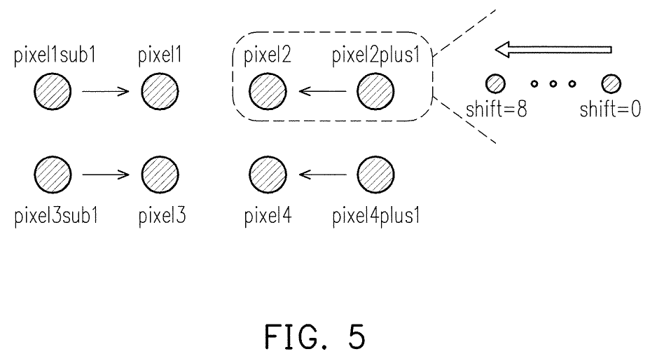

FIG. 5 is a schematic view of the reference pixels depicted in FIG. 3 shifted by the weighted factor according to an embodiment of the invention. With reference to FIG. 2 and FIG. 5, in one embodiment, the neighborhood pixel processing circuit 220 may adjust the reference pixels Si according to the weighted factor by adjusting the reference pixels as:

pixel1sub1=pixel1+(pixel1sub1−pixel1)>>shift (5)

pixel2plus1=pixel2+(pixel2plus1−pixel2)>>shift (6)

pixel3sub1=pixel3+(pixel3sub1−pixel3)>>shift (7)

pixel4plus1=pixel4+(pixel4plus1−pixel4)>>shift, (8)

where pixel1sub1, pixel1, pixel2, and pixel2plus1 represent the grayscale values of the pixels of the input image on one side of the interpolated pixel in sequence, and pixel3sub1, pixel3, pixel4, and pixel4plus1 represent the grayscale values of the pixels of the input image on the other side of the interpolated pixel in sequence. That is, in a coordinate system where the interpolated pixel (e.g. location of pixel Sx in FIG. 3) is defined as the origin, the pixels having the grayscale values pixel2 and pixel2plus1 may be located in a first quadrant, the pixels having the grayscale values pixel1sub1 and pixel1 may be located in a second quadrant, the pixels having the grayscale values pixel3sub1 and pixel3 may be located in a third quadrant, and the pixels having the grayscale values pixel4 and pixel4plus1 may be located in a fourth quadrant. In the present embodiment, the >> operator represents the right shift operation, and the weighted factor may be an integer from 0 to 8. When the weighted factor equals or approaches 8, the right shift operation is equivalent to a division by 256, and the grayscale values pixel1sub1, pixel2plus1, pixel3sub1, and pixel4plus1 are shifted to be the same as the grayscale values pixel1, pixel2, pixel3, and pixel4. On the other hand, when the weighted factor equals or approaches 0, the grayscale values pixel1sub1, pixel2plus1, pixel3sub1, and pixel4plus1 are unchanged. In other words, when the weighted factor equals 8 or approaches 8, the correction of the grayscale values of pixel1sub1, pixel2plus1, pixel3sub1, and pixel4plus1 also corrects the negative spatial response of Lanczos filtering, such as eliminating the negative spatial response and overshoot effect of Lanczos2 filtering at the edges. When the weighted factor equals 0 or approaches 0, the spatial response does not need correction, and the interpolated pixels are calculated without adjustments to the reference pixels to retain more image details. Since the neighborhood pixel processing circuit 220 performs the right shift operation in equations (5)-(8), the neighborhood pixel processing circuit 220 can avoid complex hardware implementations and rely on simple shifter elements. Accordingly, the neighborhood pixel processing circuit 220 provides the adjusted reference pixels to the coefficient calculating and interpolation circuit 230. However, it should be noted that the neighborhood pixel processing circuit 220 may also adjust the reference pixels Si using other implementations. For example, in one embodiment, the neighborhood pixel processing circuit 220 may also adjust the reference pixels Si by adjusting the reference pixels as:

$$\begin{matrix}pixel 1 sub 1 = pixel 1 \times ( 1 - \frac{rect}{255} ) + pixel 1 sub 1 \times ( \frac{rect}{255} ) & ( 9 ) \\ pixel 2 plus 1 = pixel 2 \times ( 1 - \frac{rect}{255} ) + pixel 2 plus 1 \times ( \frac{rect}{255} ) & ( 10 ) \\ pixel 3 sub 1 = pixel 3 \times ( 1 - \frac{rect}{255} ) + pixel 3 sub 1 \times ( \frac{rect}{255} ) & ( 11 ) \\ pixel 4 plus 1 = pixel 4 \times ( 1 - \frac{rect}{255} ) + pixel 4 plus 1 \times ( \frac{rect}{255} ) & ( 12 )\end{matrix}$$

Referring to FIG. 2, based on the adjusted reference pixels, the coefficient calculating and interpolation circuit 230 may generate the output image IMG_OUT by performing an interpolation process based on a sinc filter. In the present embodiment, the coefficient calculating and interpolation circuit 230 calculates the pixels in the output image IMG_OUT as:

$$S ( x ) = {\sum }_{i = ⌊ x ⌋ - a + 1}^{⌊ x ⌋ + a} {S}_{i} L ( x - i ) , \qquad ( 13 )$$

in which L(x) represents a windowed sinc filter and is defined as:

$$L ( x ) = \{ \begin{matrix}1 & if x = 0 \\ \frac{a sin ( π x ) sin ( π x / a )}{{π}^{2} {x}^{2}} & if 0 < \vert x \vert < a \\ 0 & otherwise\end{matrix} , \qquad ( 14 )$$

where S(x) represents the interpolated pixel in the output image IMG_OUT, Sᵢ represents the adjusted reference pixels near the interpolated pixel (e.g. near the location of pixel Sx in FIG. 3), a is a sampling size determined by the coefficient calculating and interpolation circuit 230 according to the adjusted reference pixels, and x is the distance from the interpolated pixel to one of the reference pixels in the x direction (e.g. dx in FIG. 3), and i is an integer. In equation (13), the └ ┘ symbol represents a floor function. In the present embodiment, the sampling size a may be selected as 2, although other sampling sizes may be selected by the coefficient calculating and interpolation circuit 230 based on the adjusted reference pixels, and the invention is not limited thereto. The output image IMG_OUT may be transmitted to a display (not drawn), for example, although the invention is not limited thereto.

In view of the foregoing, according to embodiments of the invention, the image processing method and apparatus reduce the computational loading of the Lanczos2 resampling kernel, while also correcting for overshoot artifacts and maintaining image details.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An image processing method, comprising:
detecting a pixel content of an input image around an interpolated pixel to obtain a weighted factor;
adjusting a plurality of reference pixels according to the weighted factor; and
generating an output image by performing an interpolation process based on a sinc filter according to the adjusted reference pixels;
wherein the image processing method is performed using an integrated circuit or computer program.

2. The image processing method according to claim 1, wherein the step of generating the output image by performing the interpolation process based on the sinc filter according to the adjusted reference pixels comprises:
calculating the pixels in the output image as:
$$S ( x ) = {\sum }_{i = ⌊ x ⌋ - a + 1}^{⌊ x ⌋ + a} {S}_{i} L ( x - i ) ,$$
wherein L(x) represents the sinc filter and is defined as:
$$L ( x ) = \{ \begin{matrix}1 & if x = 0 \\ \frac{a sin ( π x ) sin ( π x / a )}{{π}^{2} {x}^{2}} & if 0 < \vert x \vert < a \\ 0 & otherwise\end{matrix} ,$$
where S(x) represents the interpolated pixel in the output image, Sᵢ represents the reference pixels near the interpolated pixel, a is a sampling size, and x is a distance from the interpolated pixel to one of the reference pixels in one direction, and i is an integer.

3. The image processing method according to claim 2, wherein only one line of reference pixels on each of two opposite sides of the interpolated pixel is used to generate the pixels in the output image.

4. The image processing method according to claim 2, wherein a=2.

5. The image processing method according to claim 1, wherein the step of detecting the pixel content of the input image at the interpolated pixel to obtain the weighted factor comprises:
calculating the weighted factor by characterizing a plurality of pixels near the interpolated pixel.

6. The image processing method according to claim 5, wherein the step of calculating the weighted factor by characterizing the pixels near the interpolated pixel comprises:
calculating the weighted factor as:
shift=max(┌W×rect+M┐,S), wherein
rect is a content trait analyzing function, shift is the weighted factor, and W, M, and S are variables.

7. The image processing method according to claim 6, wherein W=−½, M=8, and S=0.

8. The image processing method according to claim 6, wherein the step of calculating the weighted factor by characterizing the pixels near the interpolated pixel further comprises:
calculating the content trait analyzing function rect as:
rect=max(|Vₚᵢₓₑₗ₁−Vₚᵢₓₑₗ₃|,|Vₚᵢₓₑₗ₂−Vₚᵢₓₑₗ₄|),
wherein Vₚᵢₓₑₗ₁, Vₚᵢₓₑₗ₂, Vₚᵢₓₑₗ₃ and Vₚᵢₓₑₗ₄ are pixel brightness of four pixels near the interpolated pixel.

9. The image processing method according to claim 6, wherein the step of calculating the weighted factor by characterizing the pixels near the interpolated pixel further comprises:
calculating the content trait analyzing function rect as:
rect=min((max(|Vₚᵢₓₑₗ₁ₘᵢₙᵤₛ₁−Vₚᵢₓₑₗ₃ₘᵢₙᵤₛ₁|,|Vₚᵢₓₑₗ₁−Vₚᵢₓₑₗ₃|)),(max(|Vₚᵢₓₑₗ₂ₚₗᵤₛ₁−Vₚᵢₓₑₗ₄ₚₗᵤₛ₁|,|Vₚᵢₓₑₗ₂−Vₚᵢₓₑₗ₄|))),
wherein Vₚᵢₓₑₗ₁ₘᵢₙᵤₛ₁, Vₚᵢₓₑₗ₁, Vₚᵢₓₑₗ₂, Vₚᵢₓₑₗ₂ₚₗᵤₛ₁, Vₚᵢₓₑₗ₃ₘᵢₙᵤₛ₁, Vₚᵢₓₑₗ₃, Vₚᵢₓₑₗ₄ and Vₚᵢₓₑₗ₄ₚₗᵤₛ₁ are pixel brightness of eight pixels near the interpolated pixel.

10. The image processing method according to claim 6, wherein the step of calculating the weighted factor by characterizing the pixels near the interpolated pixel further comprises:
calculating the content trait analyzing function rect as:
rect=min((max(l₁,l₃)),(max(l₂,l₄))), wherein
l₁=ABS3(pixel1, pixel2, pixel2plus1)
l₂=ABS3(pixel1, pixel2, pixel1minus1)
l₃=ABS3(pixel3, pixel4, pixel4plus1)
l₄=ABS3(pixel3, pixel4, pixel3minus1)
wherein ABS3(a,b,c)=MAX(a,b,c)−min(a,b,c), and Vₚᵢₓₑₗ₁ₘᵢₙᵤₛ₁, Vₚᵢₓₑₗ₁, Vₚᵢₓₑₗ₂, Vₚᵢₓₑₗ₂ₚₗᵤₛ₁, Vₚᵢₓₑₗ₃ₘᵢₙᵤₛ₁, Vₚᵢₓₑₗ₃, Vₚᵢₓₑₗ₄ and Vₚᵢₓₑₗ₄ₚₗᵤₛ₁ are pixel brightness of eight pixels near the interpolated pixel.

11. The image processing method according to claim 1, wherein the step of adjusting the reference pixel values according to the weighted factor comprises:
adjusting the reference pixels as:
pixel1sub1=pixel1+(pixel1sub1−pixel1)>>shift
pixel2plus1=pixel2+(pixel2plus1−pixel2)>>shift
pixel3sub1=pixel3+(pixel3sub1−pixel3)>>shift
pixel4plus1=pixel4+(pixel4plus1−pixel4)>>shift,
where pixel1sub1, pixel1, pixel2, and pixel2plus1 represent the grayscale values of the pixels of the input image on one side of the interpolated pixel in sequence, and pixel3sub1, pixel3, pixel4, and pixel4plus1 represent the grayscale values of the pixels of the input image on another side of the interpolated pixel in sequence.

12. The image processing method according to claim 11, wherein in a coordinate system where the interpolated pixel is defined as the origin, the pixels having the grayscale values pixel2 and pixel2plus1 are located in a first quadrant, the pixels having the grayscale values pixel1sub1 and pixel1 are located in a second quadrant, the pixels having the grayscale values pixel3sub1 and pixel3 are located in a third quadrant, and the pixels having the grayscale values pixel4 and pixel4plus1 are located in a fourth quadrant.

13. The image processing method according to claim 1, wherein the step of adjusting the reference pixel values according to the weighted factor comprises:
adjusting the reference pixels as:
$$\begin{matrix}pixel 1 sub 1 = pixel 1 \times ( 1 - \frac{rect}{255} ) + pixel 1 sub 1 \times ( \frac{rect}{255} ) , \\ pixel 2 plus 1 = pixel 2 \times ( 1 - \frac{rect}{255} ) + pixel 2 plus 1 \times ( \frac{rect}{255} ) , \\ pixel 3 sub 1 = pixel 3 \times ( 1 - \frac{rect}{255} ) + pixel 3 sub 1 \times ( \frac{rect}{255} ) , and \\ pixel 4 plus 1 = pixel 4 \times ( 1 - \frac{rect}{255} ) + pixel 4 plus 1 \times ( \frac{rect}{255} ) ,\end{matrix}$$
where the content trait analyzing function rect is served as the weighted factor, pixel1sub1, pixel1, pixel2, and pixel2plus1 represent the grayscale values of the pixels of the input image on one side of the interpolated pixel in sequence, and pixel3sub1, pixel3, pixel4, and pixel4plus1 represent the grayscale values of the pixels of the input image on another side of the interpolated pixel in sequence,
wherein in a coordinate system where the interpolated pixel is defined as the origin, the pixels having the grayscale values pixel2 and pixel2plus1 are located in a first quadrant, the pixels having the grayscale values pixel1sub1 and pixel1 are located in a second quadrant, the pixels having the grayscale values pixel3sub1 and pixel3 are located in a third quadrant, and the pixels having the grayscale values pixel4 and pixel4plus1 are located in a fourth quadrant.

14. An image processing apparatus, comprising:
a neighborhood pixel content analyzer circuit, configured to receive an input image and detect a pixel content of the input image around an interpolated pixel to obtain a weighted factor;
a neighborhood pixel processing circuit, coupled to the neighborhood pixel content analyzer circuit to receive the weighted factor, and configured to adjust a plurality of reference pixels to obtain a plurality of adjusted reference pixels according to the weighted factor; and
a coefficient calculating and interpolation circuit, coupled to the neighborhood pixel processing circuit, and configured to generate an output image by performing an interpolation process based on a sinc filter according to the adjusted reference pixels.

15. The image processing apparatus according to claim 14, wherein the coefficient calculating and interpolation circuit is configured to generate the output image by performing the interpolation process based on the sinc filter according to the adjusted reference pixels comprises:
calculating the pixels in the output image as:
$$S ( x ) = {\sum }_{i = ⌊ x ⌋ - a + 1}^{⌊ x ⌋ + a} {S}_{i} L ( x - i ) ,$$
wherein L(x) represents the sinc filter and is defined as:
$$L ( x ) = \{ \begin{matrix}1 & if x = 0 \\ \frac{a sin ( π x ) sin ( π x / a )}{{π}^{2} {x}^{2}} & if 0 < \vert x \vert < a \\ 0 & otherwise\end{matrix} ,$$
where S(x) represents the interpolated pixel in the output image, Sᵢ represents the reference pixels near the interpolated pixel, a is a sampling size, and x is a distance from the interpolated pixel to one of the reference pixels in one direction, and i is an integer.

16. The image processing apparatus according to claim 15, wherein only one line of reference pixels on each of two opposite sides of the interpolated pixel is used to generate the pixels in the output image.

17. The image processing apparatus according to claim 15, wherein a=2.

18. The image processing apparatus according to claim 14, wherein the neighborhood pixel content analyzer circuit is configured to detect the pixel content of the input image at the interpolated pixel to obtain the weighted factor by characterizing a plurality of pixels near the interpolated pixel.

19. The image processing apparatus according to claim 18, wherein the neighborhood pixel content analyzer circuit is configured to calculate the weighted factor as:
shift=max(┌W×rect+M┐,S), wherein
rect is a content trait analyzing function, shift is the weighted factor, and W, M, and S are variables.

20. The image processing apparatus according to claim 19, wherein W=−½, M=8, and S=0.

21. The image processing apparatus according to claim 19, wherein the neighborhood pixel content analyzer circuit is configured to calculate the content trait analyzing function rect as:
rect=max(|Vₚᵢₓₑₗ₁−Vₚᵢₓₑₗ₃|,|Vₚᵢₓₑₗ₂−Vₚᵢₓₑₗ₄|),
wherein Vₚᵢₓₑₗ₁, Vₚᵢₓₑₗ₂, Vₚᵢₓₑₗ₃ and Vₚᵢₓₑₗ₄ are pixel brightness of four pixels near the interpolated pixel.

22. The image processing apparatus according to claim 19, wherein the neighborhood pixel content analyzer circuit is configured to calculate the content trait analyzing function rect as:
rect=min((max(|Vₚᵢₓₑₗ₁ₘᵢₙᵤₛ₁−Vₚᵢₓₑₗ₃ₘᵢₙᵤₛ₁|,|Vₚᵢₓₑₗ₁−Vₚᵢₓₑₗ₃|)),(max(|Vₚᵢₓₑₗ₂ₚₗᵤₛ₁−Vₚᵢₓₑₗ₄ₚₗᵤₛ₁|,|Vₚᵢₓₑₗ₂−Vₚᵢₓₑₗ₄|))),
wherein Vₚᵢₓₑₗ₁ₘᵢₙᵤₛ₁, Vₚᵢₓₑₗ₁, Vₚᵢₓₑₗ₂, Vₚᵢₓₑₗ₂ₚₗᵤₛ₁, Vₚᵢₓₑₗ₃ₘᵢₙᵤₛ₁, Vₚᵢₓₑₗ₃, Vₚᵢₓₑₗ₄ and Vₚᵢₓₑₗ₄ₚₗᵤₛ₁ are pixel brightness of eight pixels near the interpolated pixel.

23. The image processing apparatus according to claim 19, wherein the neighborhood pixel content analyzer circuit is configured to calculate the content trait analyzing function rect as:
rect=min((max(l₁,l₃)),(max(l₂,l₄))), wherein
l₁=ABS3(pixel1, pixel2, pixel2plus1)
l₂=ABS3(pixel1, pixel2, pixel1minus1)
l₃=ABS3(pixel3, pixel4, pixel4plus1)
l₄=ABS3(pixel3, pixel4, pixel3minus1)
wherein ABS3(a,b,c)=MAX(a,b,c)−min(a,b,c), and Vₚᵢₓₑₗ₁ₘᵢₙᵤₛ₁, Vₚᵢₓₑₗ₁, Vₚᵢₓₑₗ₂, Vₚᵢₓₑₗ₂ₚₗᵤₛ₁, Vₚᵢₓₑₗ₃ₘᵢₙᵤₛ₁, Vₚᵢₓₑₗ₃, Vₚᵢₓₑₗ₄ and Vₚᵢₓₑₗ₄ₚₗᵤₛ₁ are pixel brightness of eight pixels near the interpolated pixel.

24. The image processing apparatus according to claim 14, wherein the neighborhood pixel processing circuit is configured to adjust the reference pixels according to the weighted factor by adjusting the reference pixels as:
pixel1sub1=pixel1+(pixel1sub1−pixel1)>>shift
pixel2plus1=pixel2+(pixel2plus1−pixel2)>>shift
pixel3sub1=pixel3+(pixel3sub1−pixel3)>>shift
pixel4plus1=pixel4+(pixel4plus1−pixel4)>>shift,
where pixel1sub1, pixel1, pixel2, and pixel2plus1 represent the grayscale values of the pixels of the input image on one side of the interpolated pixel in sequence, and pixel3sub1, pixel3, pixel4, and pixel4plus1 represent the grayscale values of the pixels of the input image on another side of the interpolated pixel in sequence.

25. The image processing apparatus according to claim 24, wherein in a coordinate system where the interpolated pixel is defined as the origin, the pixels having the grayscale values pixel2 and pixel2plus1 are located in a first quadrant, the pixels having the grayscale values pixel1sub1 and pixel1 are located in a second quadrant, the pixels having the grayscale values pixel3sub1 and pixel3 are located in a third quadrant, and the pixels having the grayscale values pixel4 and pixel4plus1 are located in a fourth quadrant.

26. The image processing apparatus according to claim 14, wherein the neighborhood pixel processing circuit is configured to adjust the reference pixels according to the weighted factor by adjusting the reference pixels as:
$$\begin{matrix}pixel 1 sub 1 = pixel 1 \times ( 1 - \frac{rect}{255} ) + pixel 1 sub 1 \times ( \frac{rect}{255} ) , \\ pixel 2 plus 1 = pixel 2 \times ( 1 - \frac{rect}{255} ) + pixel 2 plus 1 \times ( \frac{rect}{255} ) , \\ pixel 3 sub 1 = pixel 3 \times ( 1 - \frac{rect}{255} ) + pixel 3 sub 1 \times ( \frac{rect}{255} ) , and \\ pixel 4 plus 1 = pixel 4 \times ( 1 - \frac{rect}{255} ) + pixel 4 plus 1 \times ( \frac{rect}{255} ) ,\end{matrix}$$
where the content trait analyzing function rect is served as the weighted factor, pixel1sub1, pixel1, pixel2, and pixel2plus1 represent the grayscale values of the pixels of the input image on one side of the interpolated pixel in sequence, and pixel3sub1, pixel3, pixel4, and pixel4plus1 represent the grayscale values of the pixels of the input image on another side of the interpolated pixel in sequence,
wherein in a coordinate system where the interpolated pixel is defined as the origin, the pixels having the grayscale values pixel2 and pixel2plus1 are located in a first quadrant, the pixels having the grayscale values pixel1sub1 and pixel1 are located in a second quadrant, the pixels having the grayscale values pixel3sub1 and pixel3 are located in a third quadrant, and the pixels having the grayscale values pixel4 and pixel4plus1 are located in a fourth quadrant.
